(19) United States
(12) Patent Application Publication
(10) Pub. No.: US 2003/0127893 A1
(43) Pub. Date: Jul. 10, 2003

(54) Baby carriage auxiliary seat

(76) Inventor: Oren Wolstein, Kfar Saba (IL)

Correspondence Address: DR. MARK FRIEDMAN LTD., C/o Bill Polkinghorn, Discovery Dispatch, 9003 Florin Way, Upper Marlboro, MD, 20772, US

(21) Appl. No.: 10/036,511

(22) Filed: Jan. 7, 2002

(51) Int. Cl. B60N 2/26

(52) U.S. Cl. 297/250.1

(57) ABSTRACT

An auxiliary seat for mounting on a baby carriage is disclosed which includes a seat bench, designed and configured to be mounted on the baby carriage in a substantially horizontal orientation, and including a mechanism for adjusting a length of the seat bench to enable mounting of the seat bench to carriages having a range of widths. The auxiliary seat further includes at least one first seat attachment element disposed at a respective end of the seat bench length adjusting mechanism, each configured to engage at least one respective structural member of the carriage, and at least one second seat attachment element disposed at a respective end of the seat bench length adjusting mechanism. The at least one second seat attachment element further includes a resilient element configured to secure the at least one second attachment element to the respective at least one structural member of the carriage.

### FIELD AND BACKGROUND OF THE INVENTION

The present invention relates to seats for baby carriages, and in particular, it concerns a child's auxiliary seat that is attachable to a baby carriage.

### BACKGROUND OF THE INVENTION

Baby carriages are primarily designed to accommodate one newborn or infant child up to approximately 2-3 years of age. In many cases, an older child accompanies the carriage user, in which case it may be desirable to transport the older child as well. It would be desirable to have a seating device that can be easily attached to the carriage that can accommodate an older child, preferably up to the age of 5-6 years, so as to provide such transport. Such device should be lightweight, safe, able to be attached to virtually any commonly found baby carriage, easy to maintain, and easy to affix and detach from the carriage.

In the teachings of the prior art, as disclosed in U.S. Pat. No. 1,409,331 and depicted in FIGS. 1A-1D (prior art), an auxiliary seat is provided to accommodate a small child without interference with the normal use of the carriage for small infants. As can be seen in FIGS. 1A-1D, the auxiliary seat is designed specifically for use with a particular type of carriage depicted, being designed and configured to attach to a specific carriage structural member arrangement characteristic of a particular carriage configuration. With reference to the figures, carriage body 10 is supported on wheels 11, with rearwardly extending handlebars 12 attached to carriage body 10. One end of the carriage is cut away to form opening 13. The body of the carriage is reinforced longitudinally and transversely as well as vertically through the medium of metallic bars or reinforcing members 14 arranged in any suitable manner. A supporting member is provided in the form of a pair of rods 15 connected together at their adjacent ends by means of a turnbuckle 16 and having their remote ends connected to the sides of the carriage body or reinforcing members 14 located therein. This bar is located adjacent the cutaway end of the carriage body in order to support the seat which consists of a seat portion 17, a leg rest 18 extending downward therefrom and a foot rest 19. A back and sides 20 may be formed of wicker, reed or any other material desired. Iron bars 21 are provided and are secured to the seat portion and back and are formed with pressed out portions 22 which receive rods 15, thus mounting the seat for swinging movement from the position shown in full lines in FIG. 1B to the dotted position thereof.

As seen in the figures, the mechanism for mounting and supporting the auxiliary seat is not rigid and leaves the seat and its passenger susceptible to undesired and excessive movements. Further, it is clear from inspection of the figure that the seat design and configuration and location of attachment hardware are suitable for the particular carriage depicted, and is not adjustable for use with a plurality of carriages. Further, the device is not suitable for carriages that are in popular use today, which are provided with a low, substantially rectangular horizontal frame extending towards the user, eliminating the option of hanging an auxiliary seat frontwards from a carriage frame, as taught in the prior art.

Therefore, it would be desirable to have a child's auxiliary seat to accommodate an older child up to the age of 5-6 years, which is suitable for use with a wide variety of carriages in popular use today, lightweight, safe, adaptable to a plurality of carriages, easy to mount and detach from a carriage, and simple and inexpensive to manufacture.

### SUMMARY OF THE INVENTION

According to the present invention, there is provided an auxiliary seat for mounting on a carriage, the auxiliary seat including (a) a seat bench designed and configured to be mounted on the carriage in a substantially horizontal orientation (b) at least one first seat attachment element disposed at a respective end of the seat bench, each first seat attachment element configured to engage at least one respective structural member of the carriage; and (c) at least one second seat attachment element disposed at a respective end of the seat bench, the at least one second seat attachment element including a resilient element configured to secure the at least one second attachment element to the respective at least one structural member of the carriage.

According to the present invention, there is provided an auxiliary seat for mounting on a carriage, the auxiliary seat including (a) a seat bench designed and configured to be mounted on the carriage in a substantially horizontal orientation, the seat bench including a mechanism for adjusting a length of the seat bench to enable mounting of the seat bench to carriages having a range of widths; (b) at least one first seat attachment element disposed at a respective end of the mechanism for adjusting a length of the seat bench, each the at least one first seat attachment element configured to engage at least one respective structural member of the carriage; and (c) at least one second seat attachment element disposed at a respective end of the mechanism for adjusting a length of the seat bench, the at least one second seat attachment element further comprising a resilient element configured to secure the at least one second attachment element to the respective at least one structural member of the carriage.

According to the present invention there is provided a method of adapting a carriage to transport a plurality of children, the method including the steps of (a) providing an auxiliary seat that includes a seat bench including a mechanism for adjusting a length of the seat bench, (b) adjusting the seat bench to fit the carriage; and (c) mounting the auxiliary seat on the carriage with the seat bench in a substantially horizontal orientation.

According to further features of the described preferred embodiments of the invention, the mechanism for adjusting the length of the seat bench includes (i) at least one extension element slidingly mounted within a channel attached to the seat bench, and (ii) a mechanism for fixing the at least one extension element in place relative to the seat bench.

According to yet further features of the described preferred embodiments of the invention, the mechanism for fixing the at least one extension element in place includes at least one device mounted in the seat back and engaging the at least one extension element.

According to yet further features of the described preferred embodiments of the invention, the at least one device engaging the at least one extension element is a setscrew, a bolt, a nail, or a peg.

According to yet further features of the described preferred embodiments of the invention, the at least one extension element includes a mechanism providing at least one mounting surface that is substantially in the same geometric plane as a bottom surface of the channel.

According to yet further features of the described preferred embodiments of the invention, each the at least one first seat attachment mechanism includes a bracket designed and configured to engage the respective at least one structural member of the carriage by clamping to the structural member.

According to yet further features of the described preferred embodiments of the invention, each the at least one first seat attachment mechanism includes a mechanism for adjusting a fore to aft position of the each at least one first seat attachment mechanism relative to the seat bench.

According to yet further features of the described preferred embodiments of the invention, each at least one first seat attachment element includes a mechanism for adjusting a vertical position of each at least one first seat attachment mechanism relative to the seat bench.

According to yet further features of the described preferred embodiments of the invention, each the at least one second seat attachment mechanism includes a mechanism for adjusting a fore to aft position of the each at least one second seat attachment mechanism relative to the seat bench.

According to yet further features of the described preferred embodiments of the invention, the auxiliary seat includes a substantially vertically disposed seat back attached to the seat bench.

According to yet further features of the described preferred embodiments of the invention, the auxiliary seat includes a mechanism for securing a child to the auxiliary seat.

According to yet further features of the described preferred embodiments of the invention, the resilient element is a Velcro-equipped strap, a belt, a chain, a band, a string, a lace or a cord.

According to yet further features of the described preferred embodiments of the invention, the seat bench and the seat back are constructed as one piece.

According to yet further features of the described preferred embodiments of the invention, the seat bench and/or the seat back is furnished with padding.

The present invention successfully addresses the shortcomings of the existing technologies by providing an auxiliary seat, for mounting on a carriage, that is lightweight, safe to use, adaptable to a plurality of carriages, easy to mount and detach from a carriage, and simple and inexpensive to manufacture, relative to the prior art.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A, 1B, 1C and 1D (prior art) depict an auxiliary seat according to the teachings of U.S. Pat. No. 1,409,331.

FIG. 2A depicts a front view of an auxiliary seat for a baby carriage according to one embodiment of the invention, in which the seat bench length is not adjustable;

FIG. 2B provides a side view of the device shown in FIG. 2A;

FIG. 2C provides a top view of the device of FIG. 2A;

FIG. 2D provides a perspective view of the device shown in FIG. 2A;

FIG. 3A illustrates an example of an auxiliary seat mounted on a baby carriage according to the teachings of the invention depicted in FIGS. 2A-2D;

FIG. 3B illustrates a close-up perspective view of resilient element fastening details for mounting a fixed-length auxiliary seat on a carriage;

FIG. 4A depicts a front view of an auxiliary baby carriage seat according to another preferred embodiment of the invention, in which a seat bench is furnished with extension elements for adjusting a seat bench length;

FIG. 4B provides a side view of the device shown in FIG. 4A;

FIG. 4C provides a top view of the device of FIG. 4A;

FIG. 4D provides a perspective view of the device shown in FIG. 4A;

FIG. 5 illustrates a bottom view of the device shown in FIG. 4A;

FIG. 6 illustrates a rear view of the device shown in FIG. 4A;

FIG. 7 illustrates an example of an auxiliary seat mounted on a baby carriage according to the teachings of the invention depicted in FIG. 4A; and

FIG. 8 illustrates a close-up perspective view of resilient element fastening details for mounting an adjustable-length auxiliary seat on a carriage.

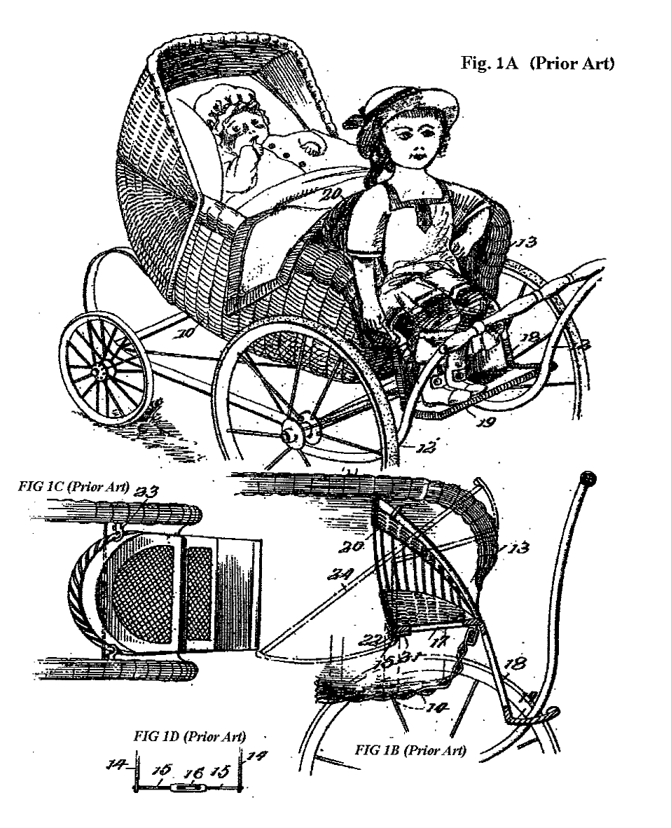

### DESCRIPTION OF THE PREFERRED EMBODIMENTS

The present invention is an auxiliary seat for mounting on a baby carriage to enable simultaneous transport of a small child in addition to a baby.

The principles and operation of the auxiliary seat according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting

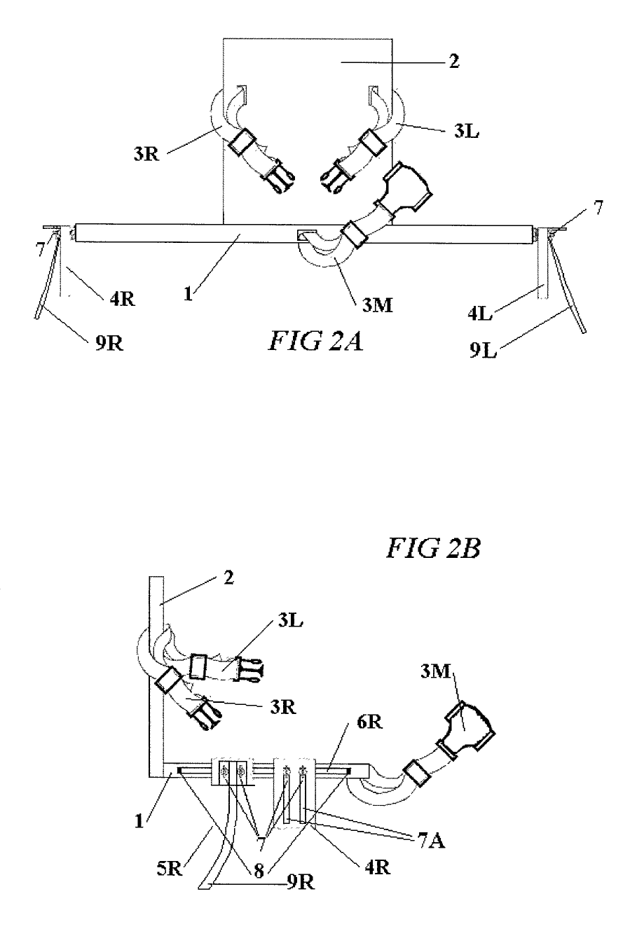

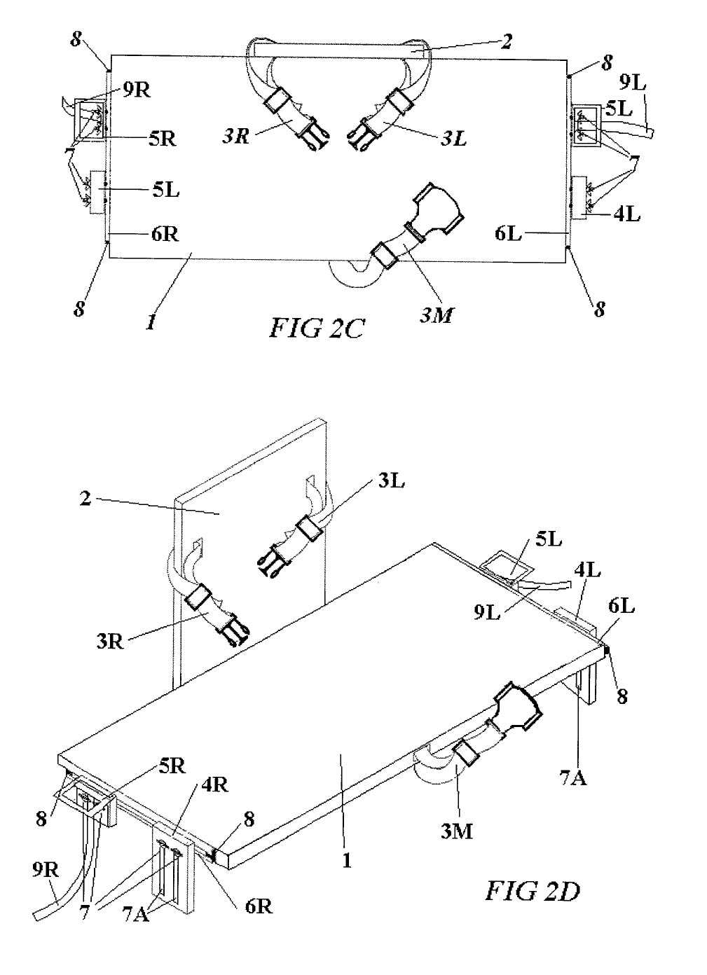

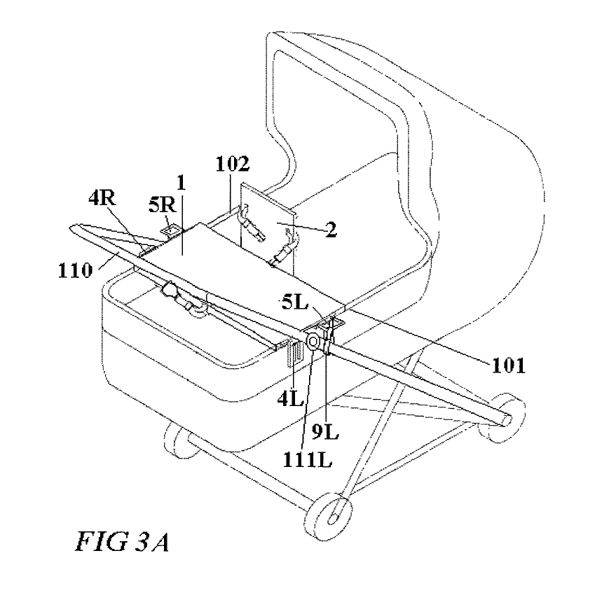

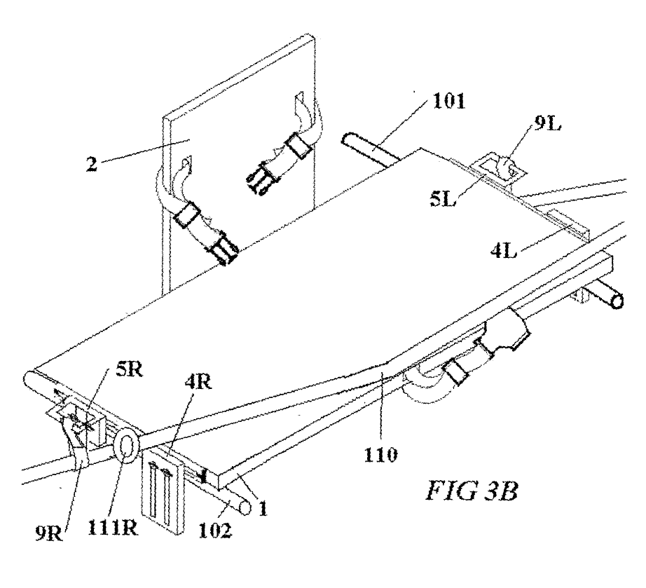

Referring now to the drawings, FIGS. 2A-2D, FIG. 3A and FIG. 3B illustrate one form of the apparatus constructed in accordance with the present invention. In a preferred embodiment of the invention, as illustrated in FIGS. 2A, 2B, 2C and 2D, a child's auxiliary seat consists of a seat bench 1 for mounting on a baby carriage in a substantially horizontal orientation, a seat back 2 is rigidly attached to seat bench 1 in a substantially vertical orientation. Attachment of seat back 2 to seat bench 1 is preferably accomplished using suitable fastening hardware (not shown) that are capable of rigidly attaching seat back 2 to seat bench 1, for example, screws, bolts, nails or other suitable devices. Alternatively, seat back 2 and seat bench 1 preferably are constructed as a single unit, preferably from a thermoplastic material or other suitable material such as metal or wood, thereby eliminating the need for fastening hardware.

Right seat belt 3R and left seat belt 3L are attached to seat back 2 and middle seat belt 3M is attached to seat bench 1, as shown in the figures, with the aid of loops in the belts which are engaged to seat bench 1 and seat back 2 through slots in the surfaces of seat bench 1 and seat back 2.

In a preferred embodiment of the invention, seat bench 1 and/or seat back 2 are preferably padded or upholstered to provide comfortable passenger support.

A right front mounting bracket 4R and a left front mounting bracket 4L are slidingly mounted onto each end of seat bench 1 using suitable fastening hardware, such as wing nuts 7 screwed onto bolts having heads slidingly mounted within rails 6R and 6L. Rails 6R and 6L are equipped at each end with rubber, plastic, metal or wooden stops 8 to prevent disengagement of fastening nuts 7 by limiting the fore to aft range of motion of fastening nuts 7. This arrangement enables a user to adjust a fore to aft position of right front bracket 4R and left front bracket 4L to enable accommodation of a wide variety of carriage designs. In addition, vertical slots 7A are provided in right front bracket 4R and in left front bracket 4L to accommodate fastening nuts 7 while enabling adjustment of the vertical disposition of front attachment brackets 4R and 4L. Front attachment bracket vertical disposition adjustability allows a user to position front brackets 4R and 4L for a variety of carriage designs such that front brackets 4R and 4L are locked in place with respect to the seat, while being in firm contact with a bottom-facing surface of carriage handle bar 110, as illustrated in FIG. 3B. This positioning of front attachment brackets 4R and 4L prevents the seat from tilting backwards in the event that an occupant of the seat leans backwards with respect to the seat, since an upward movement of front brackets 4R and 4L, which would necessarily occur if the seat were to tilt backwards, is limited by handle bar 110. Right rear bracket 5R and left rear bracket 5L are similarly slidingly attached to seat bench 1. Rear brackets 5R and 5L are furnished with resilient elements 9R and 9L, respectively, for engaging carriage structural members. Front and rear brackets 4R, 4L, 5R and 5L are preferably constructed of a rigid material such as wood, metal or plastic.

Adjustment by a user of fore to aft positions of brackets 4R, 4L, 5R and 5L is necessary to firmly mount the apparatus on a baby carriage. Fore to aft position adjustability allows a user to mount a seat onto a plurality of baby carriages of various designs, despite differences in spatial disposition of structural members, to ensure that the auxiliary seat is securely mounted to a baby carriage for its safe use. However, the preferred embodiment of the invention is limited in applicability to carriages having a width virtually equal to a distance between inward facing surfaces of brackets 4R and 4L, and between 5R and 5L.

FIG. 3A illustrates an auxiliary seat mounted on a carriage according to the teachings of a preferred embodiment of the invention. As depicted in FIG. 3A, mounting of the device on a carriage is accomplished by placing an auxiliary seat on a baby carriage such that seat bench 1 is disposed substantially horizontally and is supported by carriage structural elements 101 and 102. At this point, front brackets 4R and 4L are clamped down by a user upon structural elements 101 and 102, respectively, while positioned in front (towards the user) of carriage handle bar 110. Rear brackets 5R and 5L are positioned to the rear of handle bar 110 (away from a user). Front brackets 4R and 4L, which are slidingly mounted in rails 6R and 6L (illustrated to better advantage in FIGS. 2A-2D), are then pushed toward the back of a carriage (away from the user) and adjusted vertically until front brackets 4R and 4L are in contact with a bottom-facing surface of carriage handle bar 110. Since carriage handle bar 110 will generally be disposed in a diagonal orientation, the respective areas of contact of front brackets 4R and 4L with carriage handle bar 110 will generally be limited to the seat rear-facing upper comers of front brackets 4R and 4L. Front attachment brackets 4R and 4L are then secured in place relative to seat bench 1 by tightening fastening nuts 7.

Rear attachment brackets 5R and 5L are then positioned at any convenient fore to aft location in back of carriage handle bar 110, within a range of motion defined by handle bar 110 and a rubber or plastic stop 8 disposed at each end of mounting rails 6R and 6L. Fastening nuts 7 disposed on brackets 5R and 5L are then tightened, fixing brackets 5R and 5L in place. An auxiliary seat is then further secured to a carriage by fastening resilient elements 9R and 9L to a lower extension of carriage handle bar 110 at points below carriage structural elements 101 and 102. In a preferred embodiment of the invention depicted in FIGS. 3A and 3B, resilient elements 9R and 9L are preferably Velcro-equipped straps secured to a lower extension of carriage handle bar 110 by pressing together mating Velcro surfaces disposed at an end and at a suitable location along the length of each strap. In other preferred embodiments of the invention, resilient elements 9R and 9L are belts, chains, bands, strings, laces or cords, and are furnished with a fastening mechanisms such as hooks, catch buckles, snap-in buckles, or various knots. After fastening resilient elements 9R and 9L to handle bar 110, upward movement of resilient elements 9R and 9L is limited by the presence of carriage handle bar pivot adjusting knobs 111R and 111L.

A small child is secured to an auxiliary seat by placing the child on the seat and extending right seat belt 3R and left seat belt 3L over the child's shoulders. Middle seat belt 3M is brought up from seat bench 1 between the child's legs and secured to right seat belt 3R and left seat belt 3L by inserting male buckles disposed at an end of right seat belt 3R and at an end of left seat belt 3L into respective receptacles of a female buckle disposed at an end of middle seat belt 3M.

Removal of the child is effected by releasing buckles at ends of seat belts 3R and 3L from middle seat belt 3M. The auxiliary seat is removed from the carriage by first releasing belts 9R and 9L to disengage the auxiliary seat from the lower extension of carriage handle bar 110, loosening nuts 7 to release brackets 4R, 4L, 5R and 5L, then lifting the auxiliary seat up and forward (towards the user) away from the mounting position of the auxiliary seat on the carriage.

In a preferred embodiment of the invention described heretofore, a seat bench 1 of an auxiliary seat according to the teachings of the invention has a fixed width, which is designed to be compatible with a baby carriage of similar width. Since ends of seat bench 1 must reach structural elements 101 and 102 of a carriage, yet must not be longer than a length defined by a distance between inward facing surfaces of handlebar 110, a device according to this preferred embodiment of the invention is thus limited in applicability to essentially one baby carriage width.

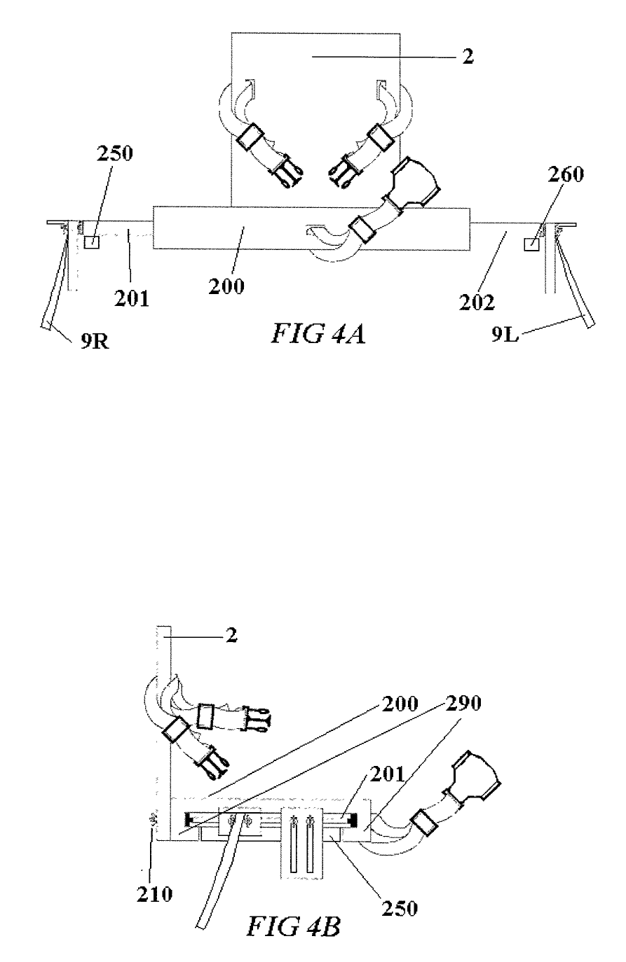

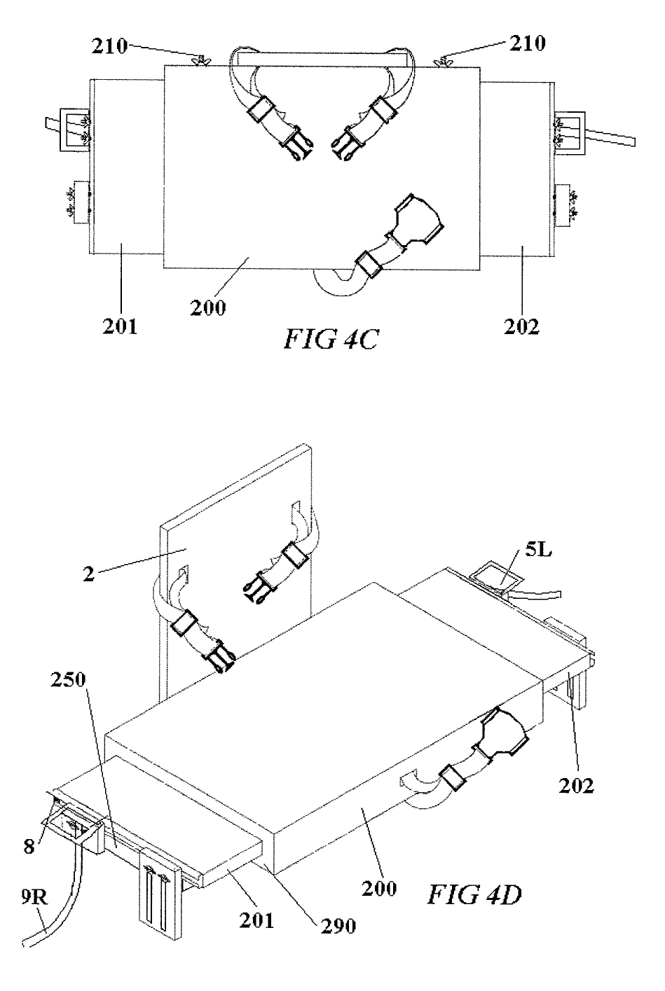

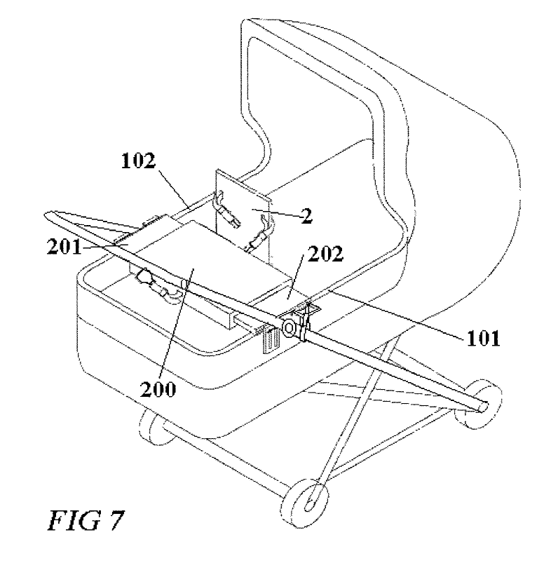

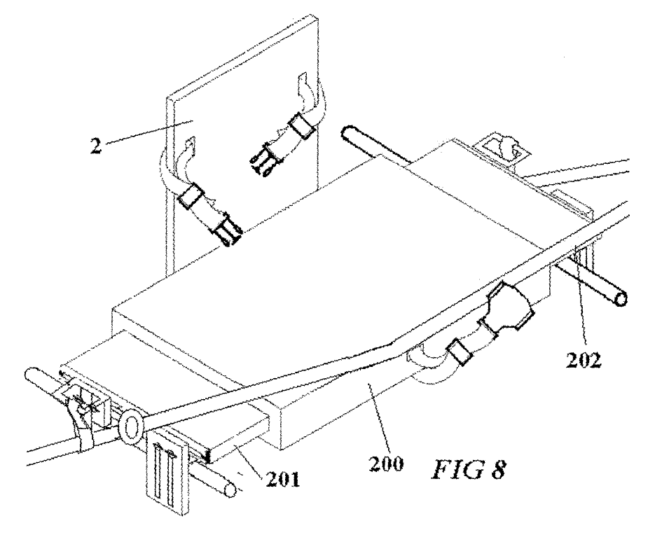

In another preferred embodiment of the invention illustrated in FIGS. 4A-4D, 5, 6, 7 and 8, a length of a seat bench is essentially variable, allowing a user to adjust a length of an auxiliary seat to accommodate carriages of various widths. As shown in the figures, a child's auxiliary seat according to the teachings of this preferred embodiment of the invention consists of a seat bench 200 for mounting on a baby carriage in a substantially horizontal orientation, having a seat back 2 attached to it as described above in a substantially vertical orientation. A bottom surface of seat bench 200 is furnished with channel 290, also shown to better advantage in FIG. 5, to provide a mechanism for slidable mounting of extension elements 201 and 202 to a bottom surface of seat bench 200. Extension elements 201 and 202 are furnished with mounting bars 250 and 260, attached to bottom surfaces of extension elements 201 and 202, respectively. The bottom surfaces of mounting bars 250 and 260 are substantially disposed in the same geometric plane as the bottom surfaces of channel 290. When mounting a seat on a carriage, a user places mounting bars 250 and 260 on carriage side frame members 101 and 102. The use of mounting bars 250 and 260 enables level mounting of the seat with respect to the carriage frame, in case the seat is positioned by a user towards the user-facing end of the carriage, such that channel 290 is mounted on a front facing-carriage frame member. Other mechanisms for accommodating extension elements are preferably applicable to enable adjustment of an effective length of seat bench 1. Extension elements are preferably constructed of a material such as wood, plastic or metal.

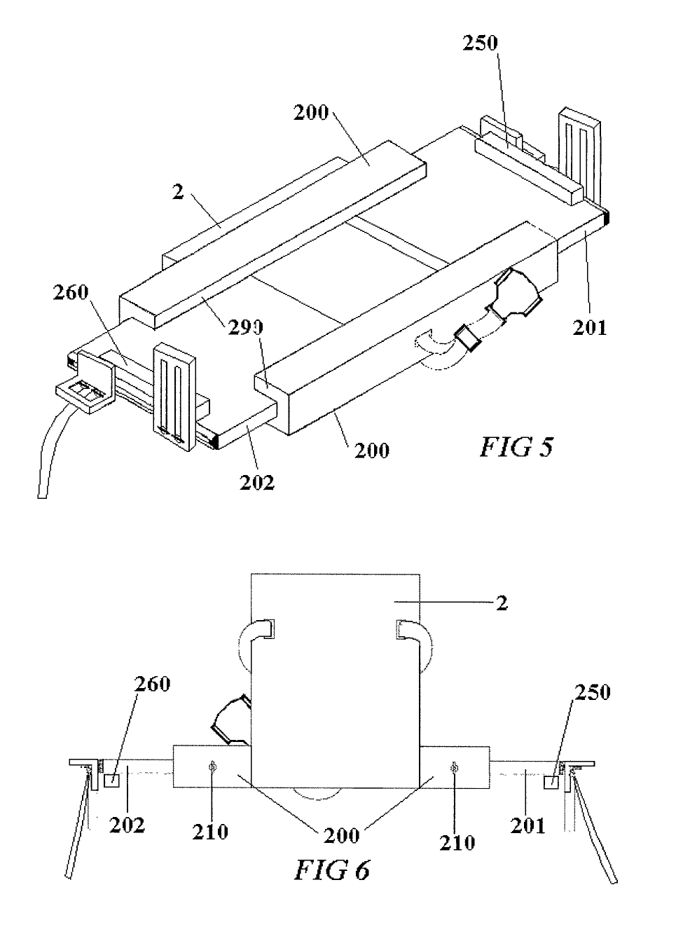

Prior to mounting an auxiliary seat onto a baby carriage, extension elements 201 and 202 are positioned by a user of the device such that an overall length of seat bench 2, including lengths of extended portions of extension elements 201 and 202, is suitable to a width of a carriage. Extension elements 201 and 202 are fixed in position relative to seat bench 200 and seat back 2 by adjusting set screws 210, shown to better advantage in FIG. 6, which are inserted through a threaded cross section of seat back 2. Set screws 210 are tightened until they press against a back surface of each extension board, thereby fixing extension boards 201 and 202 in place relative to seat bench 200. Set screws 210 may preferably be engaged in holes furnished at predetermined positions in extension boards 201 and 202, thereby defining specific discrete effective seat bench lengths for standard carriage widths. In addition to threaded screws, fixing extension elements 201 and 202 in place is preferably accomplished using nails, bolts, pins, pegs or other suitable hardware.

Once a desired seat bench length has been fixed, the seat is mounted by placing mounting bars 250 and 260 on carriage structural members 101 and 102, respectively. Further procedures for mounting of an auxiliary seat according to this embodiment of the invention, placing a child in the seat, removing the child from the seat, and removing the auxiliary seat from the carriage are performed as described previously for an auxiliary seat having a fixed length.

Although the invention has been described in a context of application to a baby carriage, it is evident that the specific embodiments can be applied to other devices having similar structural configurations such as shopping carts, wagons, strollers and other vehicles.

It will be appreciated that the above descriptions are intended only to serve as examples, and that many other embodiments are possible within the spirit and the scope of the present invention.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

Those skilled in the art will readily appreciate that various modifications and changes can be applied to various embodiments of the invention as hereinbefore exemplified without departing from its scope defined in and by the appended claims.

What is claimed is:

1. An auxiliary seat for mounting on a carriage, the auxiliary seat comprising:
(a) a seat bench designed and configured to be mounted on the carriage in a substantially horizontal orientation;
(b) at least one first seat attachment element disposed at a respective end of said seat bench, each said at least one first seat attachment element configured to engage at least one respective structural member of the carriage; and
(c) at least one second seat attachment element disposed at a respective end of said seat bench, said at least one second seat attachment element including a resilient element configured to secure said at least one second attachment element to said respective at least one structural member of the carriage.

2. The auxiliary seat of claim 1, wherein each said at least one first seat attachment element includes a bracket designed and configured to engage said respective at least one structural member of the carriage by clamping to said structural member.

3. The auxiliary seat of claim 1, wherein each said at least one first seat attachment element includes a mechanism for adjusting a fore to aft position of said each at least one first seat attachment mechanism relative to said seat bench.

4. The auxiliary seat of claim 1, wherein each said at least one first seat attachment element includes a mechanism for adjusting a vertical position of said each at least one first seat attachment mechanism relative to said seat bench.

5. The auxiliary seat of claim 1, wherein each said at least one second seat attachment element includes a mechanism for adjusting a fore to aft position of said each at least one second seat attachment mechanism relative to said seat bench.

6. The auxiliary seat of claim 1, further comprising (Four) a substantially vertically disposed seat back attached to said seat bench.

7. The auxiliary seat of claim 1, further comprising
(d) a mechanism for securing a child to the auxiliary seat.

8. The auxiliary seat of claim 1, wherein said resilient element is selected from the group consisting of Velcro-equipped straps, belts, chains, bands, strings, laces and cords.

9. The auxiliary seat of claim 6, wherein said seat bench and said seat back are constructed as one piece.

10. The auxiliary seat of claim 6, wherein at least one element of a group of elements including said seat bench and said seat back is furnished with padding.

11. An auxiliary seat for mounting on a carriage, the auxiliary seat comprising:
(a) a seat bench designed and configured to be mounted on the carriage in a substantially horizontal orientation, said seat bench including a mechanism for adjusting a length of said seat bench to enable mounting of said seat bench to carriages having a range of widths;
(b) at least one first seat attachment element disposed at a respective end of said mechanism for adjusting said length of said seat bench, each said at least one first seat attachment element configured to engage at least one respective structural member of the carriage; and
(c) at least one second seat attachment element disposed at a respective end of said mechanism for adjusting said length of said seat bench, said at least one second seat attachment element including a resilient element configured to secure said at least one second attachment element to said respective at least one structural member of the carriage.

12. The auxiliary seat of claim 11 wherein said mechanism for adjusting a length of said seat bench includes:
(i) at least one extension element slidingly mounted within a channel attached to said seat bench, and
(ii) a mechanism for fixing said at least one extension element in place relative to said seat bench.

13. The auxiliary seat of claim 11 wherein said mechanism for fixing said at least one extension element in place includes at least one device mounted in said seat back and engaging said at least one extension element.

14. The auxiliary seat of claim 13 wherein said at least one device is selected from the group consisting of setscrews, bolts, nails, and pegs.

15. The auxiliary seat of claim 12 wherein said at least one extension element includes a mechanism providing at least one mounting surface that is substantially in a common geometric plane with a bottom surface of said channel.

16. The auxiliary seat of claim 11, wherein each said at least one first seat attachment mechanism includes a bracket designed and configured to engage said respective at least one structural member of the carriage by clamping to said structural member.

17. The auxiliary seat of claim 11, wherein each said at least one first seat attachment mechanism includes a mechanism for adjusting a fore to aft position of said each at least one first seat attachment mechanism relative to said seat bench.

18. The auxiliary seat of claim 11, wherein each said at least one first seat attachment element includes a mechanism for adjusting a vertical position of said each at least one first seat attachment mechanism relative to said seat bench.

19. The auxiliary seat of claim 11, wherein each said at least one second seat attachment mechanism includes a mechanism for adjusting a fore to aft position of said each at least one second seat attachment mechanism relative to said seat bench.

20. The auxiliary seat of claim 11, further comprising
(d) a substantially vertically disposed seat back attached to said seat bench.

21. The auxiliary seat of claim 11, further comprising
(d) a mechanism for securing a child to the auxiliary seat.

22. The auxiliary seat of claim 11, wherein said resilient element is selected from the group consisting of Velcro-equipped straps, belts, chains, bands, strings, laces and cords.

23. The auxiliary seat of claim 20, wherein said seat bench and said seat back are constructed as one piece.

24. The auxiliary seat of claim 20, wherein at least one element, selected from among said seat bench and said seat back, is furnished with padding.

25. A method of adapting a carriage to transport a plurality of children, the method comprising the steps of:
(a) providing an auxiliary seat that includes a seat bench including a mechanism for adjusting a length of said seat bench,
(b) adjusting said seat bench to fit the carriage; and
(c) mounting said auxiliary seat on the carriage with said seat bench in a substantially horizontal orientation.
